(19) United States
(12) Patent Application Publication
(10) Pub. No.: US 2012/0115410 A1
(43) Pub. Date: May 10, 2012

(54) Method and Apparatus for Field Mounting of Displacement Diffusers

(76) Inventors: Vasilios Oliver, Winnipeg (CA); J. Paul Nowak, Winnipeg (CA)

(21) Appl. No.: 13/159,940

(22) Filed: Jun. 14, 2011

Related U.S. Application Data
(60) Provisional application No. 61/410,546, filed on Nov. 5, 2010.

(51) Int. Cl. F24F 7/00; B23P 19/00

(52) U.S. Cl. 454/330; 29/428

(57) ABSTRACT

A method and apparatus for field mounting of displacement diffusers comprises a displacement diffuser adapted to mount onto a mounting angle bracket attached to a wall. The displacement diffuser includes a mounting profile adapted to allow the displacement diffuser to be mounted to the mounting angle bracket secured to the wall. This adapted profile also accommodates a mounting profile cover installed on the side of the diffuser for a finished appearance.

### CROSS-REFERENCE TO RELATED APPLICATIONS

The present application claims the benefit of priority under U.S. Provisional Patent Application No. 61/410,546, having a filing date of Nov. 5, 2010.

### BACKGROUND OF THE INVENTION

1. Technical Field

This invention relates to displacement diffusers suitable for field mounting in an occupied space and a method for field mounting such displacement diffusers.

2. Prior Art

A displacement ventilation system introduces air into an occupied space at low velocities, which causes minimal induction and mixing. Displacement ventilation generally relies on the principle that thermal plumes drive the movement of the air within the space. A conventional displacement diffuser system utilizes buoyancy forces generated by heat sources such as people, lighting, computers, and electrical equipment in a room to remove contaminants and heat from the occupied zone.

Displacement diffuser units are traditionally located at or near floor level and generally supply cool air from a duct, through a grill, and along the floor of an occupied space in a thin layer. Cool air exits the displacement outlet and spreads across the floor of an occupied space in a manner similar to water flowing out of a tap. If obstructions such as furniture or partitions are encountered, the cool air will flow around and beyond the obstruction. When cool air meets a heat source such as a person or a warm piece of equipment, a portion of the conditioned air is captured by the thermal plume of the heat source, while the remainder of air continues further into the room along the floor. In a displacement ventilation system, fresh air pools at floor level and a personal thermal plume created by a person draws fresh air up the body while polluted air is extracted at the high-mounted air return. The superior air quality and low noise levels make displacement ventilation suitable for offices, classrooms, theaters, hotels or any application where air quality demands are high.

Conventional displacement diffusers comprise a housing which typically includes rear and side panels, a top cap with an air inlet and a bottom cap, a front perforated panel or grill, a duct connection and optionally a duct cover, and one or more brackets and screws or other fasteners for mounting the diffuser. The housing, grill, and one or more duct covers allow displacement diffuser systems to blend with other architectural surroundings from floor to ceiling, enhancing the architectural appeal.

Displacement diffusers are offered in many variations of shapes and sizes to best suit space ventilation and aesthetic requirements. Round, half round, flat, wall mounted, corner units with flat of curved face are possible. Other special shapes and air patterns can be implemented for use in conjunction with displacement diffuser systems in accordance with the present invention.

Although displacement ventilation systems are an effective ventilation option in many applications, installation of such systems is both difficult and time consuming. Current methods and systems for mounting displacement diffuser units involve the use of flat brackets with a plurality of protruding, hook-like features that are spaced apart to fit into corresponding matching holes on the back of the displacement diffuser unit. Visible fasteners or plastic trim strips are used in some conventional systems for blind mounting of displacement diffusers. These systems, however, present many challenges to an installer.

It is a challenge, even in the best of conditions, to lift a displacement diffuser unit or duct cover and to align blindly the holes on a displacement diffuser unit or duct cover with a plurality of corresponding hooks on a flat mounting bracket. The available lighting, space constraints, weight, and height of the displacement diffuser unit and/or duct covers can present additional challenges during blind field mounting. Installation of a duct cover used in conjunction with a conventional displacement ventilation system presents even greater challenges because all necessary parts typically are shipped loose in a box, bag, or crate, or on a pallet and require complete assembly in the field by a contractor before installation in a permanent location.

Installation of conventional displacement ventilation systems also typically involves multiple steps, including fastening a mounting plate to a mounting surface at a predetermined distance above the floor relative to the diffuser size. Further, top ducted installations require an installer to orient the displacement diffuser unit such that the air inlet is located at the top of the unit. The installer must then slide the displacement diffuser unit onto a mounting plate and apply pressure to the housing of the diffuser to lock it into place. Bottom ducted installations require the displacement diffuser unit to be oriented such that the air inlet is located at the bottom of the unit. The displacement diffuser unit must then be slid onto the mounting plate and locked into place. Rear ducted installations, similarly, must be oriented such that the air inlet is located at the rear, and then mounted as described above. Finally, side-ducted installations require the air inlet to be located at the side of the displacement diffuser unit before it can be locked into place.

After the displacement diffuser mounting step has been performed, optional duct covers can then be mounted in the field in conjunction with the mounted displacement diffuser. Because conventional duct covers typically cannot be shipped onsite in a pre-assembled state, the installer must spend additional time: prepping the displacement diffuser to receive one or more optional duct covers; pre-assembling the one or more duct covers in the field; and then attaching the one or more duct covers to a diffuser to complete the installation.

As can be seen, this method is lengthy, laborious, detailed, and causes many installers to unnecessarily waste time, make errors, and perform an excess number of steps. Further, though conventional duct covers and caps help to create architectural appeal when a diffuser unit is installed, they are typically constructed of a plastic trim that is not custom-fitted for the application and are difficult, if not impossible, to paint.

Accordingly, there is a need for a more efficient method for field mounting displacement diffusers and optional duct covers to minimize the number of individual parts and steps. There is also a need for such an assembly and method with a uniform set of installation parameters to minimize errors. There is a further need for such an assembly and method that is inexpensive. Additionally, there is a need for an assembly and method that allows for pre-assembly of both the displacement diffuser and duct cover. Still further, there is a need for an assembly constructed from a material that is easy to paint and match to surrounding architectural features. Finally, there is a need for such an assembly and method that is simple and easy to install. It is to these needs and others that the present invention is directed.

### BRIEF SUMMARY OF INVENTION

A displacement diffuser and mounting assembly in accordance with an embodiment of the present invention provides a more efficient displacement diffuser field mounting assembly and method. A pre-assembled displacement diffuser unit includes mounting profiles, and the mounting profiles can be connected to mounting angle brackets attached to a wall. The mounting profiles provide the advantage of fast and easy mounting of the displacement diffuser unit, and optionally one or more duct covers, without the need for individually matching multiple attachment holes, pins, screws or other fasteners. Because the displacement diffuser unit and duct cover are pre-assembled, and because of the unique shape and structure of the mounting profile and mounting angle bracket, the time needed to install the displacement diffuser unit and duct cover is approximately cut in half as compared to conventional systems. Further, the mounting profiles on the sides of the diffuser housing are adapted to accommodate mounting profile covers for a finished, architecturally appealing appearance.

An embodiment of a displacement diffuser unit and mounting assembly in accordance with the present invention includes a displacement diffuser unit comprising a housing with front, back, and side panels; a top inlet cap; a bottom cap; an inner perforated baffle; corner frames; and optionally a mullion frame. The housing of the displacement diffuser unit can include one or more perforated panels included within, or included in the place of, any one or more of the front or side panels and the inner perforated baffle. The assembly can also incorporate one or more duct covers comprising a top and bottom cap; front, back, and side panels; corner frames; and optionally a mullion frame. Similarly, any one or more of the front and side panels of the duct cover can be perforated. One or more duct covers can be used in conjunction with the displacement diffuser unit to enhance the architectural appeal of the assembly.

An illustrative embodiment of the assembly further includes a mounting angle bracket for mounting the displacement diffuser unit and one or more duct covers onto a mounting surface of an occupied space. The mounting angle bracket comprises a pair of mounting arms that join at a common vertex. A mounting profile is adapted to attach to and couple with the mounting angle bracket and the housing of a displacement diffuser unit and/or a duct cover. The mounting profile is preferably a unitary extrusion having a front head. The front head comprises a cover prong opposite a support prong which joins together at an end to form a panel capture channel for receiving a modified side panel and grasping the side panel in place through the application of pressure from the opposing support and cover prongs. In another embodiment of the assembly in accordance with the present invention, the mounting profile can be a retrofit for a conventional displacement diffuser unit that is separately secured to the diffuser housing with a fastener such as a rivet, pin, bolt, screw, or the like, and can be manufactured in two or more pieces.

The front head of the mounting profile is located at one end of a stabilizer bar. A pair of mounting legs and a rear attachment prong are also connected to the stabilizer bar of the mounting profile along its length. The mounting legs and stabilizer bar form a channel into which a mounting profile cover can be fitted for enhanced architectural appeal. The mounting profile cover comprises a small face plate and cover legs, and is also preferably of a unitary construction. The pair of mounting legs attaches to the mounting angle bracket attached to the mounting surface, and abut the mounting surface to provide stability to the displacement diffuser unit.

The mounting angle bracket is preferably a unitary, extruded piece comprising two mounting arms. In an exemplary embodiment, each mounting arm is disposed at an angle of approximately 90 degrees relative to the other mounting arm, and after assembly and installation, one mounting arm is substantially parallel to one mounting leg of the mounting profile. Another mounting arm is disposed on substantially the same horizontal plane as the other mounting leg, and the mounting arms and legs abut each other at their vertices.

The mounting profile cover has cover legs capable of flexing to fit into the channel and returning substantially to their original shape upon a release of pressure to form a tight, secure fit of the mounting profile cover within the channel. After the mounting angle bracket has been attached to the mounting surface, a first mounting leg of the mounting profile is fitted against a first mounting arm of the mounting angle bracket, and a second mounting leg of the mounting profile is then fitted against the mounting surface. Screws, pins, bolts, rivets, or other similar mechanical fasteners are then threaded through both the first mounting leg and the first mounting arm in order to mount the displacement diffuser unit onto the mounting surface. Additional mechanical fasteners can be added along the length of the first mounting leg in order to further secure the displacement diffuser unit to the mounting angle bracket.

The rear attachment prong connected to the stabilizer bar is substantially parallel to the front head, and comprises a screw run which receives an attachment screw or other cylindrical mechanical fastener running perpendicularly through the top inlet cap of the displacement diffuser unit and/or the top and bottom caps of the duct covers. The screw run and mechanical fastener further secure the mounting profile to the displacement diffuser unit and to the duct covers, and provide additional stability. The rear attachment prong also provides a surface upon which an inner support plate can be attached for further stability and strength.

With the inclusion of the mounting angle bracket, mounting profile, and mounting profile cover, the method for field mounting displacement diffusers in accordance with the present invention is faster and easier than conventional methods. An illustrative embodiment of the method in accordance with the present invention begins with first securing one or more mounting angle brackets to a mounting surface of an occupied space. Preferably, the mounting angle bracket will have a plurality of holes disposed along its length in order to receive screws or other suitable mechanical fasteners. Because the mounting profile of the displacement diffuser unit is adapted to mount directly to the mounting angle bracket and because the mounting profile allows for direct visual mounting by an installer, most of the assembly steps of the conventional installation systems described above are eliminated. In other words, in an illustrative embodiment, an installer receives the displacement diffuser unit in an assembled state, with the mounting profile already attached to the unit. The mounting angle bracket and the mounting profile cover are received by the installer in separated pieces. Optionally, if the duct covers are included in the assembly, the duct covers are received separately in a pre-assembled state. The displacement diffuser unit and duct covers are then attached to the mounting angle bracket, which has been previously attached to a wall or other mounting surface of an occupied space.

One feature of the present invention is a simple displacement diffuser and mounting assembly comprising pre-assembled components, mounting profiles, mounting profile covers, and mounting angle brackets that save time and effort for the installer. Another feature of the present invention is that the displacement diffuser and mounting assembly in accordance with the present invention is easy to install and compatible with a variety of unit shapes and installation locations. Another feature of the present invention is a displacement diffuser and mounting assembly and field mounting method that overcome the challenges of field installation in cramped spaces with limited visibility, allowing for full visual installation of the diffuser.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF DRAWINGS

FIG. 1 is a top view of a displacement diffuser unit in accordance with an embodiment of the present invention.

FIG. 2 is a top view of an assembled duct cover in accordance with an embodiment of the present invention.

FIG. 3 is a cross-sectional view of an embodiment of a mounting profile and a mounting profile cover in accordance with the present invention.

FIG. 3a is a perspective view of the embodiment of a mounting profile depicted in FIG. 3.

FIG. 4 is a top cross-sectional view of an embodiment of a mounting profile, mounting profile cover, and mounting angle bracket, detailing the installation of a displacement diffuser unit on a surface of an occupied space.

FIG. 5 is a partial perspective view of a mounting profile mounted to a mounting angle bracket and a displacement diffuser unit in accordance with an embodiment of the present invention.

FIG. 6 is a partial perspective view of a mounting profile including a side panel of a displacement diffuser unit and a mounting profile cover mounted therein in accordance with an embodiment of the present invention.

FIG. 7 is a perspective view of a fully installed displacement diffuser unit, a fully installed duct cover, and a partially installed duct cover in accordance with an embodiment of the displacement diffuser and mounting assembly and field mounting method of the present invention.

FIG. 8 is a top cross-sectional view of an embodiment of an installed displacement diffuser mounting assembly for a corner displacement diffuser unit, with the mounting profile and mounting angle bracket combined as a unitary extrusion, in accordance with the present invention.

FIG. 9 is a top cross-sectional view of an embodiment of a mounting profile, shown in an alternative installation without a mounting angle bracket.

FIG. 10 is an embodiment of a displacement diffuser mounting assembly installed as a retrofit for a conventional displacement diffuser unit in accordance with the present invention, which diffuser has not been modified to receive a mounting profile.

### DETAILED DESCRIPTION OF INVENTION

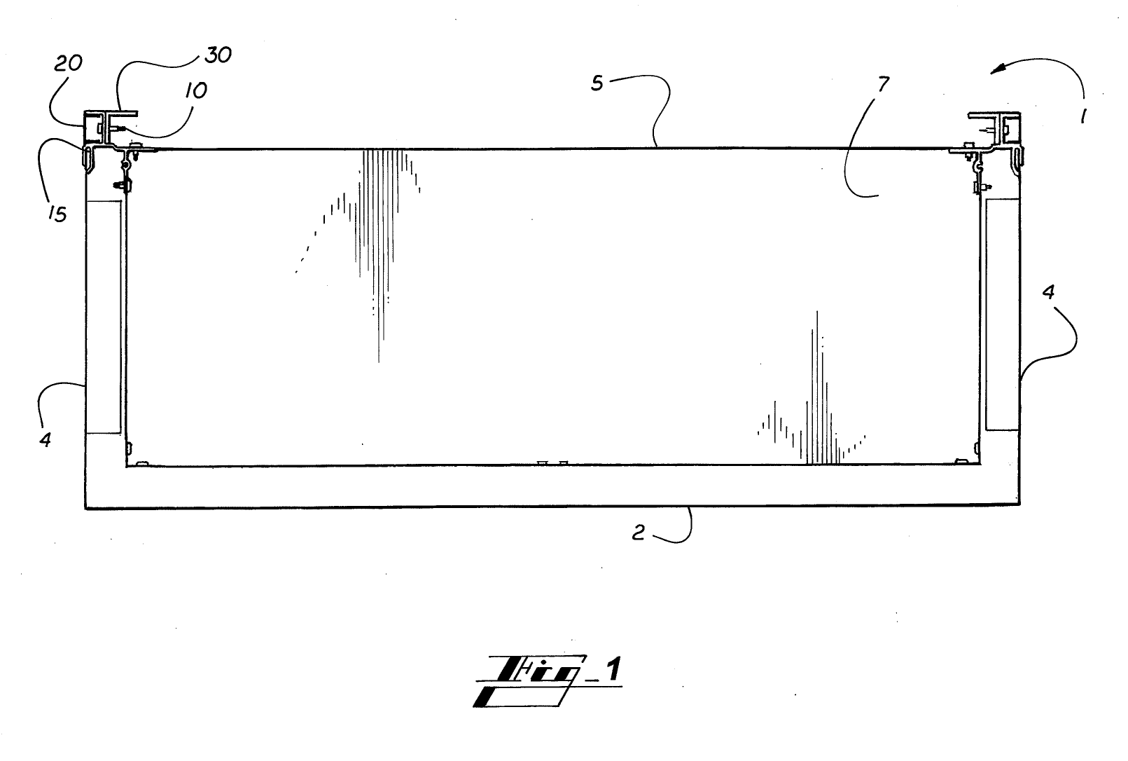

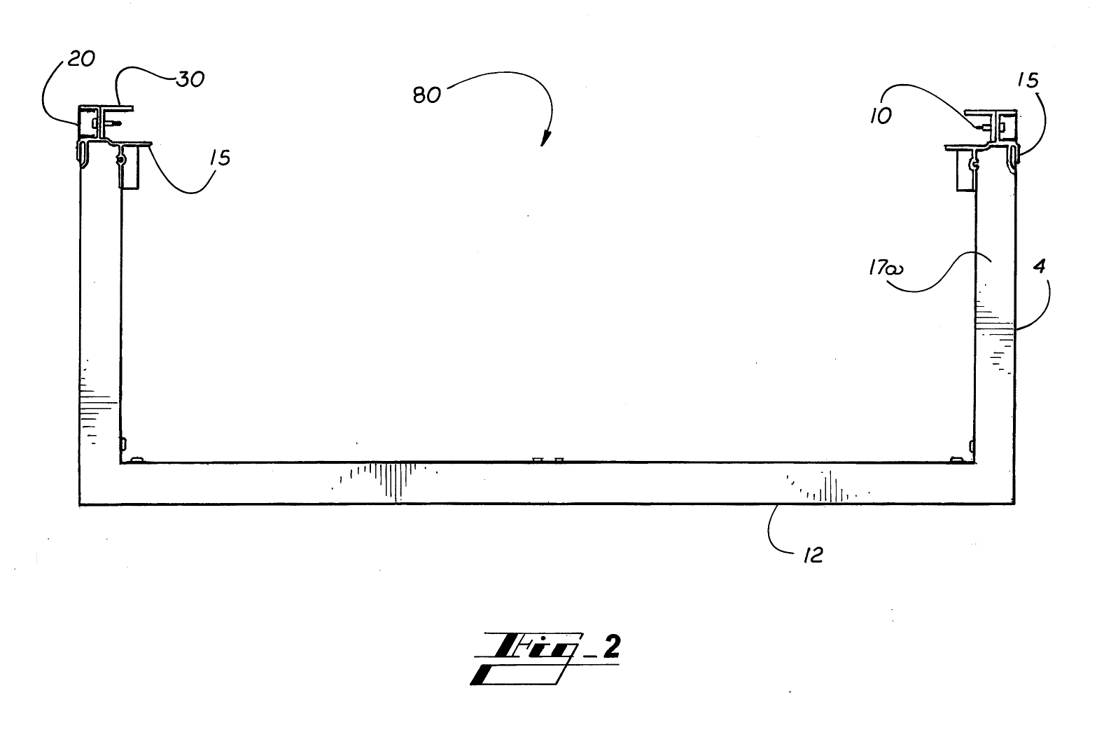

Illustrative embodiments of the assembly and method according to the present invention are shown in FIGS. 1 through 10. FIG. 1 is a top view of an assembled displacement diffuser unit as depicted unit in FIGS. 1 and 7 with the top inlet cap removed. FIG. 2 is a top view of an assembled duct cover as depicted in FIG. 7 with the top cap in place.

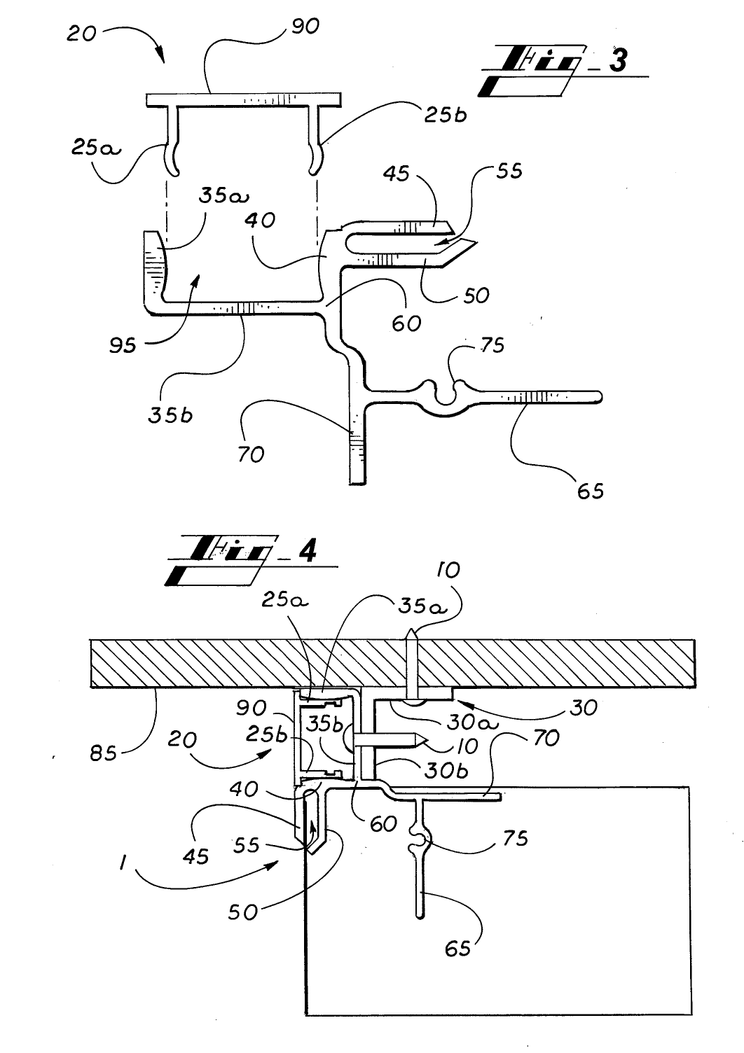

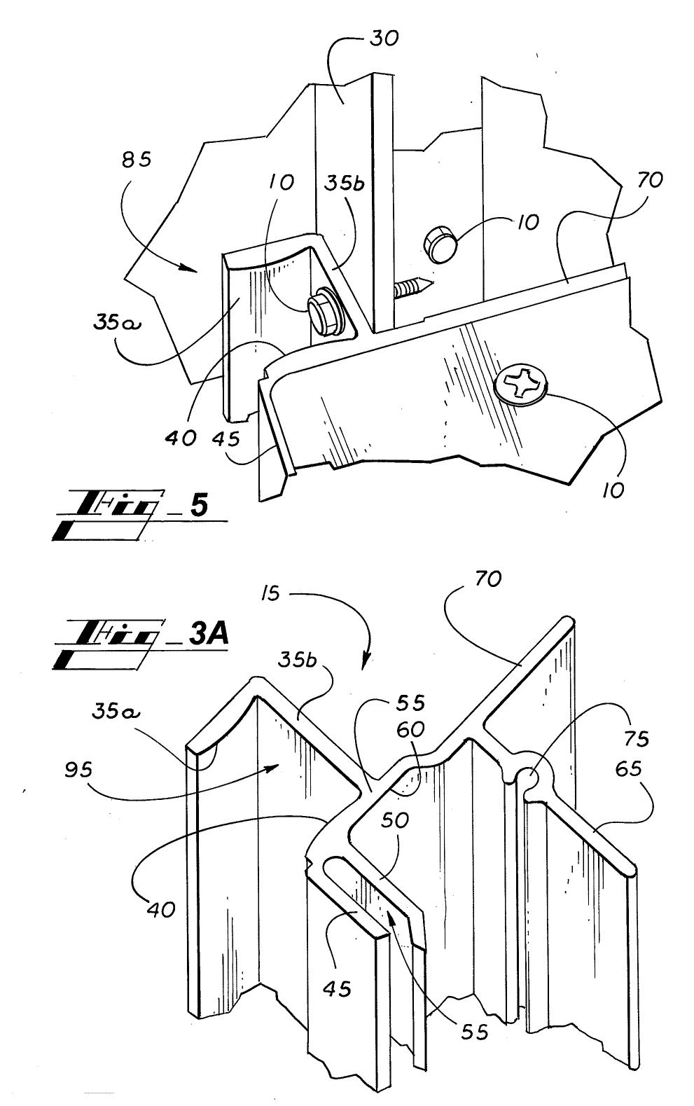

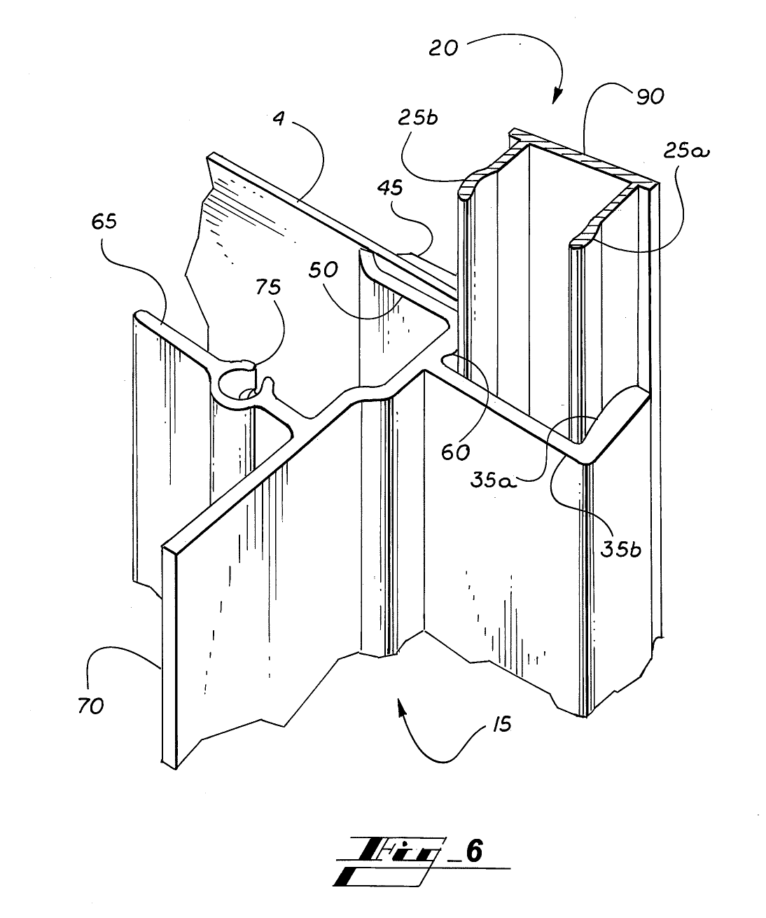

FIG. 3 is a cross-sectional view of an embodiment of a mounting profile and a mounting profile cover, detailing the installation location of the mounting profile cover. FIG. 3a is a perspective view of the embodiment of the mounting profile depicted in FIG. 3. FIG. 4 is a top cross-sectional view of the embodiment of the mounting profile depicted in FIGS. 3 and 3a, a mounting profile cover, and a mounting angle bracket detailing the installation of the embodiment of the displacement diffuser unit depicted in FIGS. 1 and 7 on a mounting surface of an occupied space. FIGS. 5 and 6 are partial elevation views of an installed mounting profile.

FIG. 5 further details the installation of a displacement diffuser unit with a mounting profile and mounting angle bracket on a mounting surface of an occupied space in accordance with an embodiment of the present invention. The mounting profile is partially obscured by a top inlet cap, and is attached to the housing of the displacement diffuser unit by a top screw, and is further attached to a mounting angle bracket by a side screw. FIG. 6 shows an embodiment of an installed mounting profile depicted in FIGS. 3, 3a, and 4 with the mounting angle bracket removed. A side panel of a displacement diffuser unit is grasped within the mounting profile, and the mounting profile cover is fitted into place within a channel formed by the mounting profile.

FIG. 7 is a perspective view of a fully installed displacement diffuser unit, one fully installed duct cover, and when partially installed duct cover in accordance with an embodiment of the displacement diffuser and mounting assembly of the present invention. The assembled displacement diffuser unit and duct covers are attached to a wall of an occupied space by a mounting profile fixed to a mounting angle bracket, and mounting profile covers are in place.

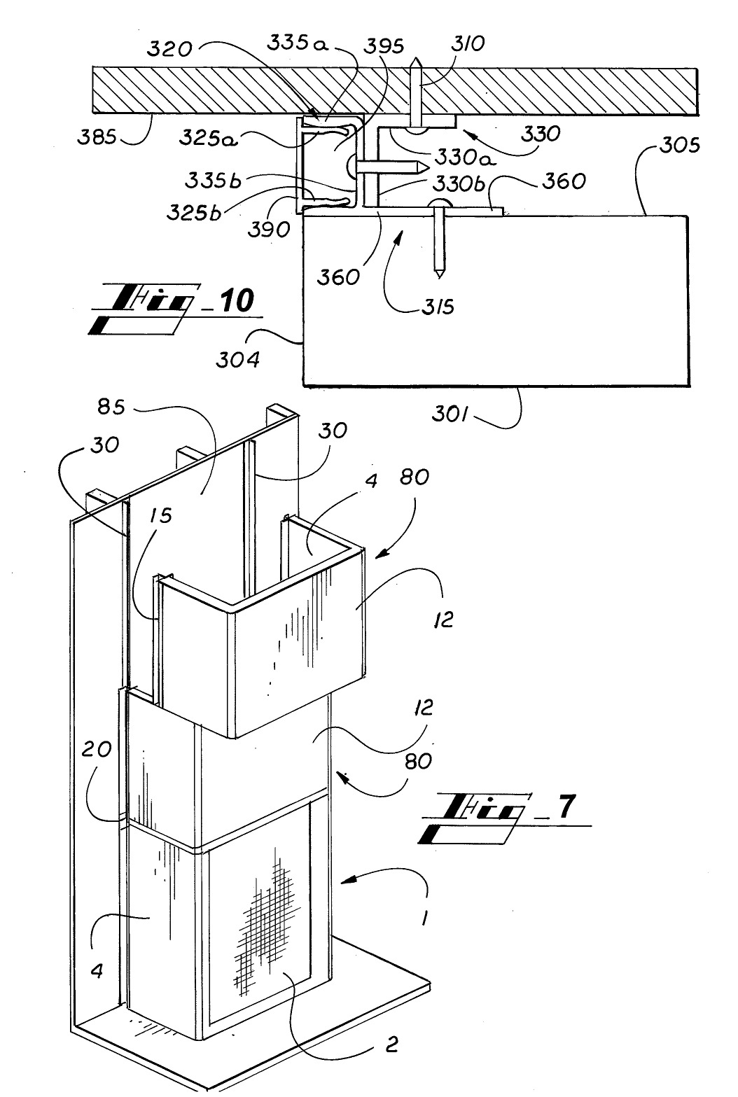

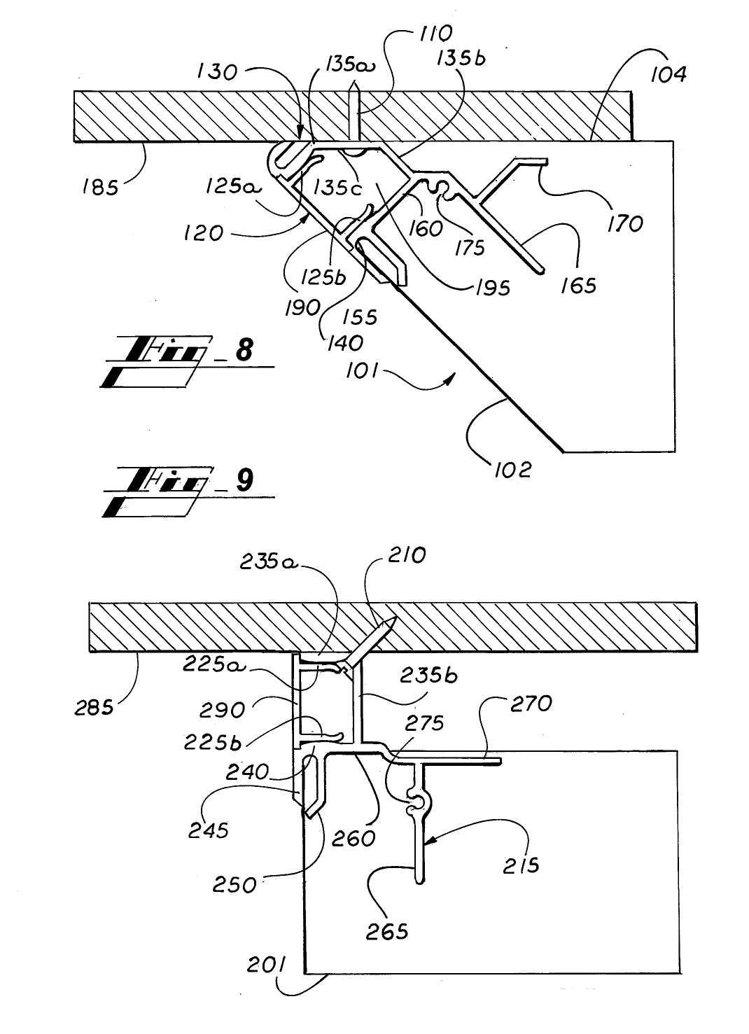

FIG. 8 is a top cross-sectional view of an alternative embodiment of a displacement diffuser mounting assembly for a corner displacement diffuser unit. The mounting profile and mounting angle bracket are combined in this embodiment as a unitary extrusion, and the configuration of the mounting profile is modified to accommodate the shape of the corner displacement diffuser unit. FIG. 9 is a top cross-sectional view of another alternative embodiment of a displacement diffuser mounting assembly, where the installation of the displacement diffuser unit is accomplished without a mounting angle bracket.

FIG. 10 is an embodiment of a displacement diffuser mounting assembly installed as a retrofit for a conventional displacement diffuser. A mounting angle bracket and mounting profile cover are an example of the embodiment depicted in FIG. 4, but a portion of the mounting profile is modified for attachment to a conventional displacement diffuser with a mechanical fastener such as a screw or rivet, or by welding.

With reference to FIGS. 1-10, an embodiment of a displacement diffuser and mounting assembly in accordance with the present invention comprises a displacement diffuser unit 1, a mounting profile cover 20, a mounting profile 15, a mounting angle bracket 30, and optionally one or more duct covers 80.

With reference to FIG. 1, a displacement diffuser unit 1 in accordance with the present invention can be conventional, or can be adapted to receive a mounting profile 15. One illustrative embodiment of a displacement diffuser unit 1 comprises a front panel 2, side panels 4, a back panel 5, a top inlet cap 6 (not shown), a bottom cap 7, one or more mounting profiles 15, one or more mounting profile covers 20, and one or more mounting angle brackets 30. A front portion is incorporated into the displacement diffuser unit by structures and methods known in the art in order to complete the displacement diffuser unit 1. The displacement diffuser unit 1 is capable of being joined to the wall, ceiling, floor, or other suitable mounting surface in an occupied space by a mechanical fastener such as a screw 10, bolt, rivet, hook, pin, nail, glue, staple, or other conventional attachment means such as welding or soldering.

An exemplary embodiment of a displacement diffuser unit 1 in accordance with the present invention can be pre-assembled. In an exemplary embodiment of a displacement diffuser unit 1, the front panel 2 of the displacement diffuser unit 1 is joined substantially perpendicularly to the front edge of the bottom cap 7. Mounting profiles 15 are likewise mounted to the bottom cap 7. Side panels 4 are attached adjacent and substantially perpendicularly to the bottom cap 7, substantially parallel to one another, and substantially perpendicular to the back panel 5.

The side edges of each side panel 4 are secured inside of a panel capture channel 55 (FIGS. 3-4) within the mounting profiles 15, which holds each side panel 4 in place with pressure. The back panel 5 is then secured to the mounting profiles 15 at a side support 70 protruding from each mounting profile 15. A top inlet cap (not shown) 6 is attached to the top end of the displacement diffuser unit 1. The side panels 4, back panel 5, front panel 2, the top inlet cap 6, and the bottom cap 7 can be secured by any conventional mechanical fastener, for example, a screw 10. An air inlet facilitates the receipt of conditioned air into the displacement diffuser unit 1, and can comprise a solid plate. The bottom cap 7 is preferably a solid plate. In one embodiment, mounting angle brackets 30 are affixed to the mounting profiles 15 and to a wall 85 to mount the displacement diffuser unit 1 to a wall 85.

With reference to FIG. 2, one or more duct covers 80 in accordance with an embodiment of the present invention can also be pre-assembled. During pre-assembly of one illustrative embodiment of a duct cover 80, the front panel 12, which can comprise one or more sections, is mounted substantially perpendicularly to the front edge of a bottom cap 17 (not shown). Mounting profiles 15 are likewise mounted to the bottom cap 17. Side panels 4 are attached adjacent and substantially perpendicularly to the side edges of the bottom cap 17, substantially parallel to one another, and substantially perpendicular to the front panel 12.

Side edges of each side panel 4 are secured inside of a panel capture channel 55 (FIGS. 3-4) within the mounting profiles 15, which holds each side panel 4 in place with pressure. A top cap 17a, bottom cap 17, front panel 12 and side panels 4 can be secured by any conventional mechanical fastener, for example, a screw 10. In one embodiment, mounting angle brackets 30 are affixed to the mounting profiles 15 or to a wall 85 to mount the duct cover 80 to a wall 85. Optionally, one or more of, or any portion of the front or side panels 12 and 4 can be perforated

A duct cover 80 in accordance with the present invention is formed from an extrusion that can be painted custom colors such that the displacement diffuser unit 1 and duct cover 80 are uniform in color. The extrusion can be, for example, made from steel or aluminum, and can be finished with paint, baking enamels, or a powder coat of a thermoplastic polymer, thermoset polymer, or the like. This is an advantage over conventional, plastic trim duct covers which are difficult, if not impossible, to paint and color uniformity cannot be achieved.

With reference to FIGS. 3-6, in accordance with an embodiment of the field installation method of the present invention, a displacement diffuser unit 1 and optionally one or more pre-assembled duct covers 80 are mounted to a wall 85 of an occupied space. In an illustrative embodiment, after the duct covers 80 have been pre-assembled and after the mounting profiles 15 have been attached to the displacement diffuser unit 1 and the duct covers 80, the displacement diffuser unit 1 and duct covers 80 are shipped to the installation site along with mounting angle brackets 30 and a mounting profile covers 20. At the site of the installation, an installer measures the width of the displacement diffuser unit 1 and attaches the mounting angle bracket 30 to the wall 85 at a width corresponding to the subject displacement diffuser unit 1 width. The mounting angle bracket 30 is also positioned substantially perpendicularly to a floor or at another desired location with screws 10 fastened at regular intervals along the length of the mounting angle bracket 30. Another mounting angle bracket 30 is fastened in the same manner parallel to the other mounting angle bracket 30 at a distance corresponding to the widths of the displacement diffuser unit 1 and any duct covers 80.

One mounting arm 30a of the mounting angle bracket 30 is affixed to the wall 85, while the other mounting arm 30b of the mounting angle bracket 30 mates with the mounting leg 35b of the mounting profile 15. Again, screws 10 or other appropriate fasteners can be used to further secure the mounting angle bracket 30 to the mounting profile 15, optionally at holes disposed upon the mounting angle bracket 30. After the mounting profile 15 has been attached to the secured mounting angle bracket 30 on one side, the process is repeated for the mounting profile 15 on the other side of the displacement diffuser unit 1.

As shown in FIG. 7, if one or more duct covers 80 are used in conjunction with the displacement diffuser unit 1 in order to enhance visual appeal, the duct covers 80 are slid into place after being aligned with and stacked on top of the displacement diffuser unit 1, and then fastened to the mounting angle brackets 30. Also optionally, a duct cover 80 can be screwed or otherwise further attached or secured to a ceiling or other mounting surface in an occupied space. Such installation of duct covers 80 improves the architectural features of an occupied space.

After the displacement diffuser unit 1 and any desired duct covers 80 have been secured to the mounting angle brackets 30 by the mounting profiles 15 disposed thereon, mounting profile covers 20 can be cut to a desired length and then fitted into channel 95 of a mounting profile 15 by either pushing or snapping the mounting profile covers 20 into place. The mounting profile cover 20 hides any unsightly seams, joints, or channels created by the displacement diffuser unit 1 or by the duct covers 80 and improves the overall aesthetic appearance of the displacement diffuser unit 1.

With reference to FIGS. 4, 5, and 7, the mounting angle bracket 30 comprises two mounting arms 30a and 30b which form an angle with respect to one another of approximately 90 degrees. The mounting angle bracket 30 is preferably a unitary extrusion which can be made from steel or aluminum, and can be finished with paint, baking enamels, or a powder coat of a thermoplastic polymer, thermoset polymer, or the like. The mounting arms 30a and 30b of the mounting angle bracket 30 preferably have a plurality of holes disposed thereon, ideally every few inches, to accommodate the attachment of the mounting angle bracket 30 to the wall 85 of an occupied space and to the mounting profile 15.

In one exemplary embodiment, the mounting angle bracket 30 is joined to a wall 85 at mounting arm 30a, and positioned so that mounting arm 30b runs perpendicular to the wall 85 and so that the vertex of the mounting arms 30a and 30b faces outward and away from the displacement diffuser unit 1. This positioning allows for the mounting of the mounting profile 15 to mounting arm 30b.

With reference to FIGS. 3, 3a, and 5, an illustrative embodiment of the mounting profile 15 for joining a displacement diffuser unit 1 to the wall 85 of an occupied space comprises a stabilizer 60 having a first end and a second end. The stabilizer 60 can be generally linear, sinusoidal, or molded to fit the profile of the edge of a diffuser housing or duct cover 80 to which it will be mated to provide maximum support and to increase the ease of attachment to displacement diffuser units 1 of various shapes and sizes mounted in different areas of an occupied space.

The mounting profile 15 comprises a front head 40 at a first end, which extends generally perpendicularly from the length of the mounting profile 15 in a first direction. The second end of the stabilizer 60 is a side support 70, which further promotes stability and provides an additional surface to which the displacement diffuser unit 1 or duct cover 80 can be attached. The side support 70 can also be substantially straight, sinusoidal, or can conform to the shape of the diffuser housing or the duct cover 80.

Along the stabilizer 60, between the front head 40 and the side support 70 at the second end of the stabilizer 60, one mounting leg 35b extends generally perpendicularly from the length of the mounting profile 15 in a second direction, generally opposite from said first direction. The mounting leg 35b is joined at a common vertex with the mounting leg 35a, which together form an angle with respect to one another of approximately 90 degrees. In use in accordance with an embodiment of the field mounting method of the present invention, the cover leg 25a is positioned adjacent the wall 85 of an occupied space, and abuts mounting the arm 30a of a mounting angle bracket (FIG. 4). Optionally, mounting legs 35a and 35b have a plurality of spaced apart holes disposed at regular intervals along the length of the mounting profile 15 to facilitate mounting the mounting profile 15 to either or both of the wall 85 of an occupied space and the mounting angle bracket 30.

In accordance with an embodiment of the mounting method of the present invention, cover leg 25b is positioned perpendicular to the wall 85 of an occupied space and directly contacts the mounting arm 30b of the mounting angle bracket 30. One or more screws 10 or other suitable attachment means join the mounting leg 35b and the mounting arm 30b through one or more of the plurality of aligned holes disposed through the mounting leg 35b and the mounting arm 30b, or directly through the surface of each. In one embodiment, the mounting leg 35a has one flat edge for flush mounting against the wall 85 of an occupied space, and one curved edge, where the profile of the mounting leg 35a has a wider middle portion with gradually tapering ends. The mounting legs 35a and 35b, together with the profile of the first end of the stabilizer 60, create a generally rectangular channel 95 into which the mounting profile cover 20 can be mounted.

The mounting profile 15 is preferably a single, unitary extrusion made from steel or aluminum and forming multiple curved, angled, and/or shaped appendages, each having a thin, sheet-like thickness. This construction is advantageous because it reduces the time for and cost of manufacturing the mounting profile 15, and reinforces its strength. Further, overall installation time of the displacement diffuser unit 1 is reduced. The mounting profile 15 is capable of being cut or extruded to any desired length corresponding generally to the height of the displacement diffuser unit 1 or greater. The mounting profile 15 is preferably finished with paint, baking enamels, or a powder coat of a thermoplastic polymer, thermoset polymer, or the like. Alternatively, the mounting profile 15 can be constructed in multiple pieces which are joined together and mounted with fasteners such as rivets, screws 10, staples, nails, by welding, or the like.

The front head 40 attaches the mounting profile 15 to the edge of the side panel 4 of the displacement diffuser unit 1 or the duct cover 80. The front head 40 comprises a cover prong 45 and a support prong 50. A side of the front head 40 forms a panel capture channel 55 with the edges of the mounting legs 35a and 35b for receiving the edge of the side panel 4 of the displacement diffuser unit 1 or the duct cover 80. The front head 40 also provides a stop or support for the edge of the side panels 4 of the displacement diffuser unit 1 or the duct cover 80, and creates a finished appearance.

The cover prong 45 is a substantially linear protrusion joined to the support prong 50 at a juncture, which is either a common vertex or a u-shaped juncture. A portion of the support prong 50 proximal to the juncture is substantially linear and parallel to the cover prong 45. A portion of the support prong 50 distal to the juncture curves or angles in a direction toward the cover prong 45. In an illustrative embodiment, the support prong 50 is either curved or angled to form a convex panel capture channel 55 in relation to a substantially straight cover prong 45. With these relative shapes, the support prong 50 and the cover prong 45 can cooperate to pinch or grasp the edge of the side panel 4 tightly without the aid of additional fasteners such as screws 10.

The support prong 50 and cover prong 45 receive the edge of the side panel 4 when the side panel 4 is inserted into the panel capture channel 55 and pushed to the back wall of the panel capture channel 55. The side panel 4 can be flexible or deformable to accommodate insertion into the panel capture channel 55. When the edge of the side panel 4 is fitted into the panel capture channel 55, the cover prong 45, which is then disposed on the outward-facing side of the side panel 4, and the support prong 50, which is then disposed on the inward-facing side of the side panel 4, apply pressure to both sides of the side panel 4.

By securely grasping the side panel 4, the cover prong 45 and the support prong 50 also further secure the pre-assembled displacement diffuser unit 1 or the duct cover 80 during shipping and handling. Further, because the mounting profile 15 is disposed on the outward-facing side of the side panel 4, the cover prong 45 provides an aesthetic element to the architectural features of the displacement diffuser unit 1 or the duct cover 80 by covering joining seams and creating a smooth, finished appearance.

The position of the front head 40 and the mounting legs 35a and 35b on one end of the stabilizer 60 provides the mounting profile 15 with stability after installation. These elements also provide further attachment points for the mechanical joining of the mounting profile 15 to the displacement diffuser unit 1 or the duct cover 80.

A rear attachment prong 65 is substantially perpendicularly mounted to the stabilizer 60 extending in a direction opposite the mounting legs 35a and 35b. The rear attachment prong 65 comprises a screw chase 75 for further securing the mounting profile 15 to the top inlet cap 6 or bottom cap 7 of the displacement diffuser unit 1 or to the top cap 17a or bottom cap 17 of the duct cover 80. In an illustrative embodiment, the rear attachment prong 65 is substantially straight, and the screw chase 75 is shaped to receive a screw 10 or other cylindrical attachment means and is integrally formed within the rear attachment prong 65. In one embodiment, the screw chase 75 is rounded to form a c-shaped channel. At the opening of the channel, the ends of the screw chase 75 can be angled to more easily accommodate a screw 10 or other cylindrical attachment vertically disposed through the displacement diffuser unit 1 or duct cover 80 and into the channel within the screw chase 75. Alternatively, the channel formed within the screw chase 75 can be mated with a vertical support bar by pushing or snapping the screw chase 75 over and around the vertical support bar during pre-assembly in order to provide additional support and stability to the displacement diffuser unit 1 or duct cover 80.

With reference to FIG. 6, the assembly in accordance with the present invention further includes the mounting profile cover 20 comprising the face plate 90 and the cover legs 25a and 25b. The mounting profile cover 20 is preferably also a unitary extrusion, with each of the cover legs 25a and 25b disposed in a substantially perpendicular position relative to the face plate 90 parallel to one another, and near the sides of the face plate 90. The cover legs 25a and 25b can have slightly angled ends, and preferably contain reciprocal shapes that mate with shapes formed by the profile of the channel 95. This facilitates the ease of mounting in the field when the mounting profile cover 20 is snapped or pushed into place within the channel 95 created by the mounting legs 35a and 35b of the mounting profile 15. In an illustrative embodiment, the cover legs 25a and 25b can temporarily deform and then return to their original shape and position such that the rounded or angular shapes formed by the profile of the channel 95 mate with and lock into reciprocal shapes disposed upon the ends of the cover legs 25a and 25b.

One illustrative embodiment of the displacement diffuser mounting assembly and method in accordance with the present invention can be seen in FIG. 4. The mounting angle bracket 30 is a unitary extrusion separate from the mounting profile 15. The mounting angle bracket 30 is formed by the two mounting arms 30a and 30b which form approximately a 90 degree angle at a common vertex. The mounting profile 15 is also a single, unitary extrusion. The mounting profile 15 comprises the stabilizer 60 with a first end and a second end. The front head 40 extends in a first direction at the first end. The rear attachment prong 65 with the screw chase 75 extends in a first direction substantially parallel to the front head 40, and is disposed between the first end and the second end of the stabilizer 60. The first mounting leg 35b extends from the stabilizer 60 in a second direction opposite the first direction, and is substantially perpendicular to the stabilizer 60. The second mounting leg 35a extends from the mounting leg 35b at a common vertex, forming approximately a 90 degree angle, and is substantially parallel to the stabilizer 60.

To field mount the displacement diffuser unit 1 or the duct cover 80 in accordance with the illustrative embodiment of the displacement diffuser mounting assembly shown in FIG. 4, the mounting arm 30a is fixed to the wall 85 with a screw 10, and then the mounting leg 35b is joined with the mounting arm 30b with another screw (FIG. 5). The side panel 4 is positioned and snapped into place within the panel capture channel 55 of the front head 40, and the back panel 5 of the displacement diffuser unit 1 is affixed to the side support 70 at the second end of the stabilizer 60. A screw 10 can then be run through the top inlet cap 6, top cap 17a, or bottom cap 17 of the displacement diffuser unit 1 or the duct cover 80 into the screw chase 75 in the rear attachment prong 65. The mounting profile cover 20 is then snapped into place within the channel 95.

An alternative embodiment of the displacement diffuser mounting assembly and method in accordance with the present invention is shown in FIG. 8. A displacement diffuser unit 101 is a corner unit mounted in a corner of an occupied space. In this embodiment, a mounting angle bracket is combined with a mounting profile to form a mounting profile bracket 130, which can be formed as a unitary extrusion. The mounting extrusion bracket 130 comprises three mounting legs 135a, 135b, and 135c. The mounting leg 135a can be a straight or curved leg or a u-shaped leg with a first side and a second side. The first side of the mounting leg 135a is joined to the mounting leg 135c at a common vertex, and the mounting legs 135b and 135c are joined at a common vertex. The angle between the first side of the mounting legs 135a and 135c and between the mounting legs 135b and 135c is greater than 90 degrees. The mounting profile bracket 130 further comprises a substantially L-shaped stabilizer 160 with a first end on a first side, a second end on a second side, and a screw chase 175 at approximately the intersection of the first side and the second side of the substantially L-shaped stabilizer 160.

A front head 140 extends in a first direction at the first end of the first side of the L-shaped stabilizer 160. The second end of the second side of the L-shaped stabilizer 160 comprises a rear attachment prong 165, which extends in a first direction substantially parallel to the front head 140. A side support 170 is disposed between the screw chase 175, at approximately the intersection of the first side and the second side of the L-shaped stabilizer 160, and the second end of the second side of the L-shaped stabilizer 160. The side support 170 extends away from a front panel 102 substantially perpendicularly to the rear attachment prong 165. A portion at a free end of the side support 170 can be angled to meet a side panel 104. The mounting leg 135b extends from the first side of the L-shaped stabilizer 160 substantially perpendicularly to the L-shaped stabilizer 160 in a second direction opposite the first direction. The L-shaped stabilizer 160 is substantially parallel to the mounting leg 135a which, together with the mounting legs 135c and 135b, forms a channel 195 into which a mounting profile cover 120 can be mounted.

To field mount the displacement diffuser unit 101 or a duct cover 180 having a corresponding shape (not shown) in accordance with the illustrative embodiment of the displacement diffuser mounting assembly shown in FIG. 8, the mounting leg 135c is placed in front of the side panel 104 and both are simultaneously fixed to a wall 185 with a screw 110. The second side of the mounting leg 135a curves toward the wall 185 or the mounting surface and meets with the mounting surface to create a finished look to increase architectural appeal. The front panel 102 is positioned and snapped into place within a panel capture channel 155 of the front head 140. The screw 110 can then be run through a top inlet cap 106 (not shown), a top cap 106a (not shown), or a bottom cap 107 (not shown) of the displacement diffuser unit 101 or the duct cover 180 into the screw chase 175. The top inlet cap 106 or top cap 106a and the bottom cap 107 are structurally similar to the top inlet cap 6, top cap 17a or 6a, and bottom cap 17 or 7, and have a shape corresponding to the displacement diffuser unit 101. Alternatively, the mounting leg 135c can be mounted directly onto the wall 185 and the side panel 104, and can be mechanically attached to the angled portion of the side support 170. Finally, the mounting profile cover 120, which comprises cover legs 125a and 125b and a face plate 190, is snapped into place within the channel 195 of the mounting profile bracket 130.

Another alternative embodiment of the displacement diffuser mounting assembly and method in accordance with the present invention can be seen in FIG. 9. A displacement diffuser unit 201 is a rectangular unit, similar to the unit depicted in FIG. 4. A mounting angle bracket is combined with a mounting profile to form a mounting profile bracket 215, which is similar to the mounting profile 15 shown in FIG. 4, but no mounting angle bracket 30 is used. The mounting profile bracket 215 further comprises a stabilizer 260 with a front head 240 at one end, a side support 270, and a rear attachment prong 265 with a screw chase 275. A mounting profile cover 220, which comprises cover legs 225a and 225b and a face plate 290, is snapped into place within a channel 295 of the mounting profile bracket 215.

To field mount the displacement diffuser unit 201 or a duct cover 280 having a corresponding shape (not shown) in accordance with the illustrative embodiment of the displacement diffuser mounting assembly shown in FIG. 9, a mounting leg 235a is placed adjacent to a wall 285. The mounting profile bracket 215 is fixed to the wall 285 with a screw 210 inserted at the vertex of the mounting legs 235a and 235b at approximately a 45 degree angle, but in any case less than a 90 degree angle, relative to the surface of the wall 285. Thereafter, the displacement diffuser unit 201 or the duct cover 280 is mounted in the manner described for the embodiment of FIG. 4, discussed above.

Yet another alternative embodiment of the displacement diffuser mounting assembly and method in accordance with the present invention can be seen in FIG. 10, which exemplifies a retrofit application. The displacement diffuser unit 301 or a duct cover 380 having a corresponding shape (not shown) is a conventional unit which has not been modified or adapted in accordance with the present invention. A mounting angle bracket 330 is a single, unitary extrusion separate from a mounting profile 315. The mounting angle bracket 330 is formed by two mounting arms 330a and 330b which form approximately a 90 degree angle at a common vertex. The mounting profile 315 comprises a substantially straight, linear stabilizer 360 with a first end and a second end. Mounting leg 335b extends in a direction perpendicular to the linear stabilizer 360. Mounting leg 335a extends from the mounting leg 335b from a common vertex at a 90 degree angle. The first end of the linear stabilizer 360 forms a wall which, together with the mounting legs 335a and 335b, creates a channel 395 into which a mounting profile cover 320 can be mounted.

To field mount the displacement diffuser unit 301 or the duct cover 380 in accordance with the illustrative embodiment of the displacement diffuser mounting assembly shown in FIG. 10, the mounting arm 330a is fixed to a wall 385 with a screw 310, and then the mounting leg 335b is joined with the mounting arm 330b with another screw 310. The first end of the linear stabilizer 360 is aligned with a side panel 304 of the conventional displacement diffuser unit 301 or the duct cover 380, and a back panel 305 of the conventional displacement diffuser unit 301 is affixed to the linear stabilizer 360 at the second end of the linear stabilizer 360 with the screw 310. The mounting profile cover 320 is then snapped into place within the channel 395.

While this invention has been described with reference to preferred embodiments thereof, it is to be understood that variations and modifications can be affected within the spirit and scope of the invention as described herein and as described in the appended claims.

What is claimed is:

1. A displacement diffuser and field mount assembly comprising:
a pre-assembled displacement diffuser unit;
one or more mounting profiles on the displacement diffuser unit;
one or more mounting angle brackets for attachment to a mounting surface capable of engaging the one or more mounting profiles; and
one or more mounting profile covers adapted to be received by the one or more mounting profiles.

2. The assembly of claim 1, further comprising one or more duct covers.

3. The assembly of claim 1, wherein the one or more mounting profile covers comprise a face plate with opposing cover legs attached thereto.

4. The assembly of claim 3, wherein the pre-assembled displacement diffuser unit includes the one or more mounting profiles attached during the pre-assembly.

5. The assembly of claim 1, wherein said one or more mounting profiles further comprises a stabilizer prong with a first and second end.

6. The assembly of claim 1, wherein the pre-assembled displacement diffuser unit includes the one or more mounting angle brackets attached during the pre-assembly.

7. The assembly of claim 5, further comprising a front head at said first end of said stabilizer.

8. The assembly of claim 5, further comprising a rear attachment prong attached to said second end of said stabilizer.

9. The assembly of claim 8, further comprising a first mounting leg extending substantially perpendicularly from said stabilizer between said first end and the rear attachment prong and a second mounting leg extending from a common vertex with said first mounting leg to form an angle of approximately 90 degrees, wherein said second mounting leg is substantially parallel to said stabilizer.

10. The assembly of claim 9, wherein the inner edges of said first and second mounting legs and said front head form a channel into which the one or more mounting profile covers can be removably attached.

11. The assembly of claim 10, wherein said one or more mounting angle brackets further comprise a first mounting arm and a second mounting arm, wherein said first and second mounting arms connect at a common vertex and form and angle of approximately 90 degrees with respect to one another.

12. The assembly of claim 11, wherein said front head further comprises a cover prong and a support prong, wherein said cover prong and support prong are capable of releasably attaching a side panel of the displacement diffuser unit.

13. The assembly of claim 12 further comprising one or more duct covers.

14. The assembly of claim 13, wherein said one or more duct covers are pre-assembled and said one or more duct covers comprise a mounting profile attached thereto.

15. A displacement diffuser and field mount retrofit assembly comprising:
a displacement diffuser unit;
one or more mounting profiles on the displacement diffuser unit comprising a substantially linear stabilizer bar, the stabilizer bar comprising:
a first mounting leg extending substantially perpendicularly from said stabilizer bar;
a second mounting leg extending from a common vertex with said first mounting leg, and forming an angle of approximately 90 degrees, wherein said second mounting leg is substantially parallel to said stabilizer bar;
a channel formed by the inner edges of said stabilizer bar and said first and second mounting legs capable of receiving a mounting profile cover;
one or more mounting profile covers, and
one or more mounting angle brackets capable of being mounted on a surface, wherein said first mounting leg of said one or more mounting profiles is capable of being mounted on said one or more mounting angle bracket, thereby attaching said one or more mounting profiles to said surface.

16. The retrofit assembly of claim 15, wherein said one or more mounting profile covers are releasably attached within the channel of said one or more mounting profiles.

17. The retrofit assembly of claim 16 further comprising one or more duct covers.

18. The retrofit assembly of claim 17, wherein said one or more duct covers further comprise one or more mounting profiles attached to said one or more duct covers.

19. A method for field mounting a displacement diffuser, the method comprising:
pre-assembling a displacement diffuser unit;
attaching one or more mounting profiles to the displacement diffuser unit;
attaching one or more mounting angle brackets to a mounting surface of an occupied space;
attaching the one or more mounting profiles to the one or more mounting angle brackets, and
fitting one or more mounting profile covers into a channel contained in the one or more mounting profiles, whereby the aesthetic quality of the displacement diffuser unit is improved.

20. The method of claim 19, further comprising:
pre-assembling one or more duct covers;
attaching one or more mounting profiles to said one or more duct covers during pre-assembly;
attaching one or more mounting angle brackets to a mounting surface;
attaching one or more mounting profiles to the one or more mounting angle brackets, and
fitting one or more mounting profile covers into a channel contained in the one or more mounting profiles, whereby the aesthetic quality of the displacement diffuser unit is improved.
